(19) United States
(12) Patent Application Publication
(10) Pub. No.: US 2007/0255493 A1
(43) Pub. Date: Nov. 1, 2007

(54) Limited destination navigation system

(76) Inventors: Ramy P. Ayoub, Arlington Heights, IL (US); Shafer B. Seymour, Bartlett, IL (US)

Correspondence Address: MOTOROLA, INC., 1303 EAST ALGONQUIN ROAD, IL01/3RD, SCHAUMBURG, IL, 60196, US

(21) Appl. No.: 11/415,004

(22) Filed: May 1, 2006

(51) Int. Cl. G01C 21/32

(52) U.S. Cl. 701/211; 701/202; 701/209; 340/995.19

(57) ABSTRACT

Systems for providing limited-destination navigational guidance to a user when driving a vehicle are disclosed. In one embodiment, the system comprises a memory pre-configured to store location information for a limited number of desired destinations. The memory is advantageously pre-configured to store a limited number of destinations before it the user even enters the vehicle. Methods for pre-programming a vehicle navigation system are also disclosed. Location information is received for a limited number of desired destinations as specified by a user. For each of the desired destinations, a user input interface is linked with the desired destination, prior to the user's entering the vehicle. Hence, rather than manually entering a destination address, a user may press one button and automatically receive navigational instructions for driving to the user's pre-designated destination.

### FIELD OF THE INVENTION

This invention relates generally to navigation systems for vehicles, and more particularly, to a simplified vehicle navigation system with limited destinations.

### BACKGROUND

Navigation systems are becoming increasingly common in vehicles. Navigation systems typically feature a display screen for displaying graphical and/or text data, such as a map showing a present position and driving directions. A user may manually input the address of a desired destination, and the navigation system may suggest one or more routes to the destination based on the map data and user's present position as supplied by a Global Positioning System (GPS) receiver.

Current navigation systems offer many different features, such as providing route guidance to nearby restaurants, hospitals, gas stations, shopping centers, parks, and other potential points of interest. Such additional features, however, are often unused. Furthermore, a significant amount of memory is required for providing such features. As a result, navigation systems have become overly complex, expensive, and difficult to use. Indeed, when faced with a complicated user interface and a multitude of features, a user may find it very cumbersome and time consuming to program and use the navigation system. Moreover, when using a particular navigation system for the first time, such as in the context of a rental car, a user may experience a high degree of difficulty and a significant length of time when programming and using the navigation system.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts block diagram of a navigation system in accordance with one embodiment of the present invention.

FIG. 2A depicts an exemplary navigation system in accordance with one embodiment of the present invention.

FIG. 2B depicts an exemplary navigation system in accordance with another embodiment of the present invention.

FIG. 3 depicts a system for pre-programming a navigation system in accordance with one embodiment of the present invention.

### DETAILED DESCRIPTION OF THE INVENTION

In accordance with embodiments of the present invention, a system for providing limited-destination navigational guidance to a user when driving a vehicle is disclosed. The system comprises a processor; a memory pre-configured to store location information for a limited number of desired destinations; a user interface coupled to the processor, comprising one or more actuators, each linked to location information for one of the desired destinations; and a network interface. The user interface is configured to provide navigational guidance information, which may be provided acoustically or visually or both. The memory is advantageously pre-configured to store location information for a limited number of destinations before the user even enters the vehicle.

In accordance with additional embodiments of the present invention, methods for pre-programming a vehicle navigation system are disclosed. Location information is received for a limited number of desired destinations as specified by a user. The desired destinations are mapped to a user input interface prior to the user's entering the vehicle.

In accordance with further embodiments of the present invention, methods for providing limited-destination navigational guidance to a user when driving a vehicle are provided. In one embodiment, location information for a limited number of desired destinations is received. The desired destinations are mapped to a user input interface prior to the user's entering the vehicle. GPS data relating to a present position of the vehicle is received. Navigational guidance is provided to the user upon selection of the user input interface. Hence, in lieu of manually entering a destination address, a user may press one button and automatically receive navigational instructions for driving to the user's pre-designated destination.

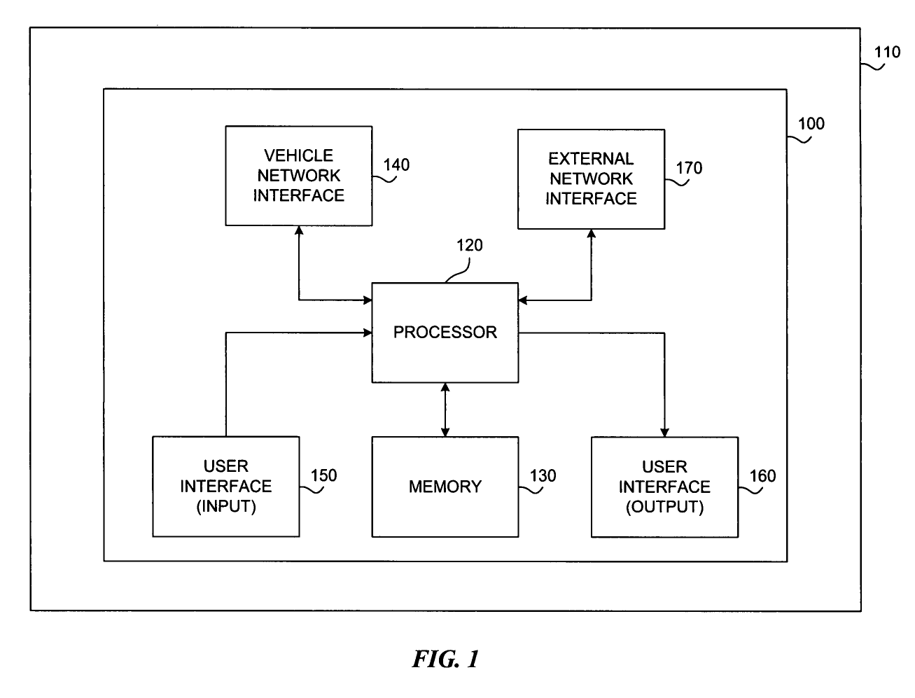

Reference is now made to FIG. 1 which depicts a block diagram for a navigation system 100 for use in a vehicle 110 in accordance with one embodiment of the present invention. The navigation system 100 may be embodied as a portable, detachable device in some embodiments. In other embodiments, the navigation system 100 may be built-in the vehicle 110, and installed, for example, in the vehicle dashboard or other suitable location accessible to the driver of the vehicle 110.

The navigation system 100 includes a processor 120 coupled to a memory 130. The memory 130 may be used to store location information corresponding to one or more pre-programmed destinations specified by the user. The memory 130 may also be used to store location information corresponding to a point of origination, such as, for example, a rental car agency location. Such location information may comprise one or more addresses. Such addresses can include information such as a street address (e.g., 123 Main Street, Schaumburg, Ill. 60196). Such location information may also include positional information, such as GPS coordinates, longitude and latitude coordinates, etc. Such location information may also include a name or label for each destination (e.g., “Hotel,” “Rental Car,” “Airport,” “Hilton®,” “Hertz®,” or “O'Hare,” etc.). Such location information may also include an image or icon representative of each destination.

The navigation system 100 may optionally include a GPS receiver for receiving present location data and map data. In other embodiments, the GPS receiver may be external to the navigation system 100. For example, an external GPS receiver may be located in or coupled to the vehicle 110 and may provide GPS data to the navigation system 100 via a vehicle network interface 140 to a vehicle data bus. Examples of a suitable data bus include without limitation a Controller Area Network (CAN) bus and a Media Oriented Systems Transport (MOST) bus. In some embodiments, GPS data may be provided to the navigation system 100 via wireless transmission. For example, GPS data may be received by a GPS receiver and wirelessly transmitted to the vehicle network interface 140 according to the Bluetooth specification, Wi-Fi, or other wireless communication protocol. GPS data may also be provided to the navigation system 100 via an on-board diagnostic (OBD) connector or other suitable vehicle network interface 140. An embodiment of the navigation system 100 without an internal GPS receiver takes advantage of the fact that many vehicles are already equipped with a GPS receiver, and therefore provides a lower-cost solution.

In some embodiments, the navigation system 100 may receive location information via the vehicle network interface 140. For example, location information may be received by a vehicle transceiver and transmitted to the vehicle network interface 140 via a vehicle data bus. Alternatively, location information may be received by a vehicle transceiver and wirelessly transmitted to the vehicle network interface 140 according to the Bluetooth specification, Wi-Fi, or other wireless communication protocol.

In other embodiments, the location information may be received by a separate interface 150 to an external network. The interface 150 may comprise a communications interface for receiving location information from, for example, a computer or server remote from the vehicle 110. In some embodiments, the interface 150 may comprise a wireless receiver including an antenna and software module for wirelessly receiving location information from a wireless transmitter. For example, the location information may be received by the interface 150 via a Wi-Fi, Bluetooth, cellular, satellite, or other wireless communication channel.

The navigation system 100 further comprises a user interface, which may comprise an input interface 150 and an output interface 160. In some embodiments, the input interface 150 may comprise one or more actuators such as button interfaces. In some embodiments, the input interface 150 may comprise a microphone for receiving audio input from the user. In some embodiments, the output interface 160 may comprise one or more speakers for providing audible navigational information; alternatively, the navigation system 100 may send audio to external speakers in the vehicle 110. In some embodiments, the output interface 160 may comprise a display screen for providing visual navigational information. In some embodiments, certain aspects of the input interface 150 and the output interface 160 may be combined, such as, for example in a touch-screen display.

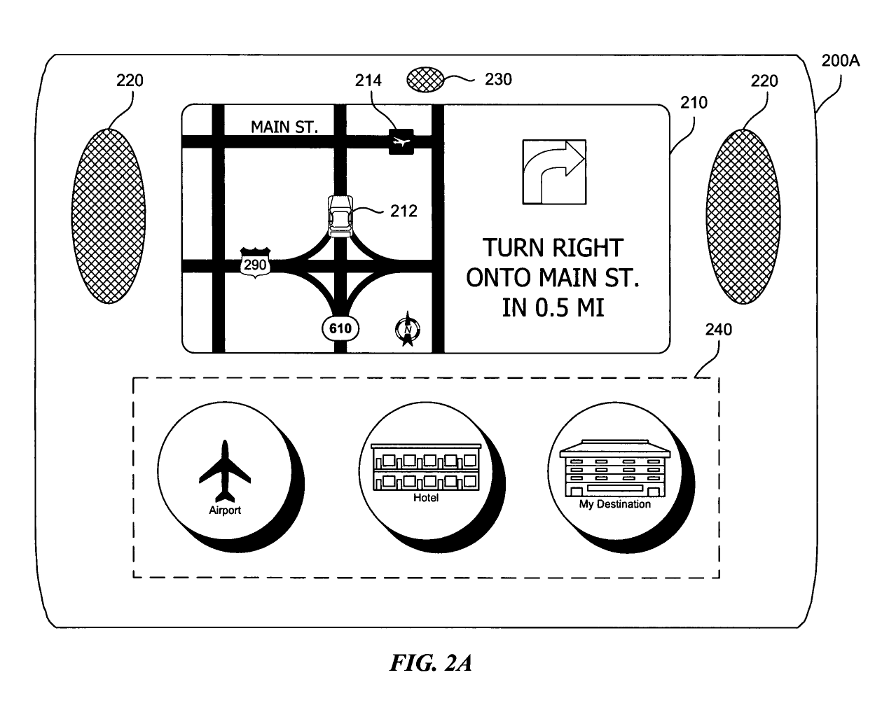

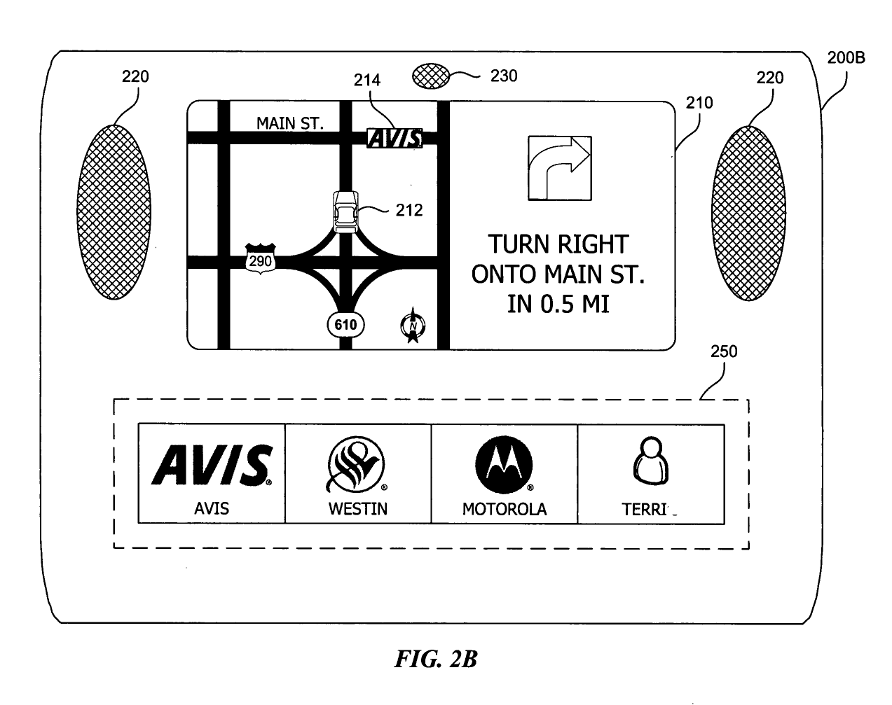

Reference is now made to FIG. 2A which depicts an exemplary user interface of one embodiment of a simplified navigation system 200A for use in a vehicle. The navigation system 200A may be a portable, detachable unit in some embodiments. In other embodiments, the navigation system 200A may be built-in the vehicle, and installed, for example, in the vehicle dashboard or other suitable location accessible to the driver.

The navigation system 200A may include an output interface comprising a display 210 for displaying graphics and/or text. For example, a graphical user interface may be used to show a map depicting present position 212, present destination 214, and/or route data. In other embodiments, the navigation system 200A may lack a display 210, and may instead provide only audible navigational information (e.g., “Turn right onto Main Street in half a mile,” or beeps or other sounds when a turn should be made, etc.) as a lower-cost solution. The navigation system 200A may comprise one or more speakers 220; alternatively, the navigation system 200A may send audio to external speakers such as speakers of a stereo system in the vehicle. The user interface may also include interactive voice response technologies. In such embodiments, a microphone 230 may be included for receiving voice commands from a user (e.g., “Go to airport” or “Return to car rental agency,” etc.).

In accordance with the present embodiment, the navigation system 200A may provide route instructions for a limited number of pre-programmed destinations. A user input interface 240 is provided which may comprise one or more actuators, such as buttons, for example. The buttons may be implemented as tactile buttons in some embodiments. In some embodiments, the buttons may be implemented in a touch-screen interface. Other suitable input means may be used.

When a particular button is selected, the navigation system 200A provides route instructions to a pre-programmed destination associated with the button. For example, when one of the buttons is selected, the navigation system 200A may provide route instructions to an airport previously designated by the user. In other embodiments, wherein the vehicle is rented from a car rental agency, for example, one of the buttons may provide route instructions to the car rental agency, which may be located at the airport. When another of the buttons is selected, the navigation system 200A may provide route instructions to a hotel previously designated by the user. When another of the buttons is selected, the navigation system 200A may provide route instructions to another destination previously designated by the user. For example, the navigation system 200A may be pre-programmed to provide route instructions to a residence or place of business that the user wishes to visit. The buttons may be labeled with an appropriate icon or text to provide a more user-friendly interface.

The one or more buttons provide a simple, user-friendly interface for the most important destinations to the user. The present embodiment may be particularly useful to a person who is using a rental car on a business trip. For example, the rental car agency (which is typically at the airport), hotel, and office are often the destinations of paramount interest to business travelers.

Reference is now made to FIG. 2B which depicts an exemplary user interface of another embodiment of a simplified navigation system 200B for use in a vehicle. The navigation system 200B may comprise components and features similar to those included in the navigation system 200A of FIG. 2A. The navigation system 200B includes a user input interface 250 which may comprise one or more actuators. The one or more actuators may comprise one or more simple liquid crystal display (LCD) displays that display text or graphics or both, corresponding to the pre-programmed destinations designated by the user. In some embodiments, the user input interface 250 may be integrated with the display 210. For example, the user input interface 250 may be embodied as a touch-screen interface.

The destinations may be designated by the user when making a reservation for a rental car. As an example, a user may plan a trip to visit Motorola in Schaumburg, Ill. including a stop to visit the home of the user's friend, Terri. The user may make travel arrangements for the trip via a travel web site, and select a flight, a reservation at the Westin hotel, and a rental vehicle from Avis, via the travel web site. The travel web site may provide the user an option to input one or more destinations of interest, and in response, the user may provide the street addresses for Motorola and Terri's house. The travel web site may provide the user an option to select text or graphics or both to be displayed on each of the limited destination navigation system actuators, corresponding to the various destinations of interest. For example, the user may, via the travel web site, configure the navigation system to display the following text on each actuator: “AVIS” (for the actuator that will provide driving directions to the rental car agency selected for the trip); “WESTIN” (for the actuator that will provide the driving directions to the hotel reserved for the trip); “MOTOROLA” (for the actuator that will provide the driving directions to the office to be visited on this trip); and “TERRI” (for the actuator representing the directions to Terri's house which will be visited during this trip). As a result, the user input interface 250 may comprise LCD displays that display the text “AVIS,” “WESTIN,” “MOTOROLA,” and “TERRI.” Images may also be displayed, as shown in FIG. 2B, such as logos corresponding to the rental car agency, hotel, and office, as well as a picture of the user's friend Terri. Thus, in accordance with the present embodiment, the user is able to remotely pre-configure the navigation system 200B to provide a customized, user-friendly user input interface 250.

Three actuators are depicted in the embodiment of FIG. 2A, and four actuators are depicted in the embodiment of FIG. 2B, for illustrative purposes. It should be understood, however, that a smaller or larger number of buttons or other actuators may be provided consistent with the principles of the present invention. For example, in one embodiment, the navigation system 200A or 200B may provide a single button corresponding to a single location of interest. The single button may correspond to a starting point, which may be, for example, a rental car agency location.

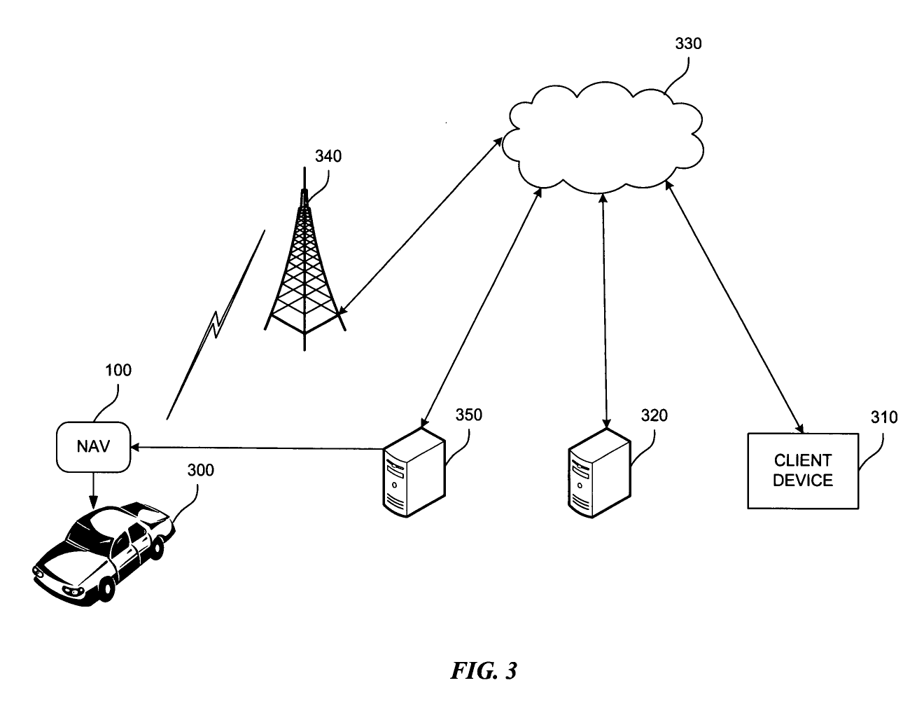

Reference is now made to FIG. 3, which depicts a system for pre-programming a navigation system, such as navigation system 100, 200A, or 200B, in accordance with one embodiment of the present invention. In the present example, a user is remotely requesting pre-programming of the navigation system 100 in connection with reserving a rental car 300. The user uses a remote client device 310 to book travel arrangements. The client device 310 may comprise, for example, a personal computer (PC), a laptop, a personal digital assistant (PDA), telephone, wireless phone, or other suitable communication device. In some embodiments, the user may book a reservation via a web site. For example, the user may enter reservation information at a web site hosted by a server 320 via a network 330, which may comprise, for example, an IP-based network such as the Internet. The web site may be operated by a rental car agency, airline, travel agency, or other entity that offers rental car reservations. In other embodiments, the user may provide reservation information via a voice call, in which case the network 330 may also comprise a circuit switched network such as the Public Switched Telephone Network (PSTN), and/or a cellular network.

In some embodiments, the user is prompted to provide the address of a desired destination, such as a city, airport, hotel, or other destination, via the web site or other communication channel. In other embodiments, the user may provide the address of a desired destination (e.g., the street address of a place of business desired to be visited), and the web site or telephone operator may suggest one or more hotels, car rental agencies, and/or airports, etc. proximate to the desired destination. The user may select a specific hotel, car rental agency, and/or airport from the suggested offerings.

If the user indicates that a rental car is desired, the user may be prompted to indicate whether the user desires to have a navigation system in the rental car. If the user indicates that a navigation system is desired, the user may be prompted to indicate whether the user desires a limited-destination navigation system. Such a limited-destination navigation system may be offered at a lower fee than a full-featured navigation system. In some embodiments, a limited-destination navigation system featuring one destination, such as the rental car agency location, may be offered for an even more reduced fee, or no fee at all.

Once the destination information is specified by the user, and the user has been assigned a vehicle, the destination information can be downloaded to the navigation system 100 via the external network interface 170. In some embodiments, the destination information may be transmitted wirelessly via a wireless base station 340 to a wireless receiver located in the rental car 300, and transmitted to the navigation system 100 via a data bus, such as a CAN or MOST bus. In other embodiments, the destination information may be wirelessly transmitted to a wireless receiver included in the navigation system 100 itself. In other embodiments, the destination information may be transmitted to the navigation system 100 from a communications device at the rental car agency that is communicably coupled to the navigation system 100. For example, the navigation system 100 may be communicably coupled to a rental car agency computer or server 350, by way of, for example, a docking station.

Once the location information is downloaded to the navigation system 100, it is ready for use with the rental car 300. The location information may be downloaded to the navigation system 100 at a later point, such as when the user arrives at the car rental agency to pick up the car 300. In some embodiments, the location information may be initially received when the user arrives at the car rental agency to pick up the car 300. In some embodiments, the location information may have already been received by the time that the user arrives at the car rental agency, but the location information can be modified before the user takes possession of the car 300.

The location information is stored in the memory 130 of the navigation system and is mapped to the interface 160. For example, the car rental agency location may correspond to one of the buttons of the interface 240 depicted in FIG. 2A. The location of the hotel selected by the user may correspond to another of the buttons of the interface 240. The location of the destination previously specified by the user, such as a place of business, may correspond to another of the buttons of the interface 240.

In another embodiment, the input user interface actuators may include simple LCD displays that will allow a user to pre-program text and/or graphics to be displayed on each of the actuators at the time of reservation. If a person is planning a trip on a travel web site, and has selected a hotel, flight information and a vehicle, the travel web site may provide the user the option to select text to be displayed on each of the limited destination navigation system actuators. For example, a user may select the following text to be displayed on each actuator: “O'Hare” (for the actuator that will provide driving directions to O'Hare international airport); “Grand Resort” (for the actuator that will provide the driving directions to the hotel reserved for this trip); and “Uncle Joe's” (for the actuator that will provide the driving directions to visit the user's Uncle Joe's house).

Advantageously, the user is able to pick up the vehicle 300, press a button corresponding to a desired destination, and automatically receive route instructions for that destination, without having to manually program the navigation system 100 or manually enter any address information into the navigation system 100, or fumble with a complicated user interface. When the user is ready to travel to the designated hotel, the user can press another button and receive route instructions for driving to the hotel. When the user is ready to travel to another desired destination, such as an office, the user can press another button and receive route instructions for driving to that destination. When the user is ready to return the vehicle, the user can press another button and receive route instructions for driving to the car rental agency.

Accordingly, embodiments of the present invention advantageously save time by providing the user with a simple, quick, and user-friendly interface for receiving route guidance for a destination. By pre-programming destinations selected by the user, the navigation systems of the present embodiments allow the user to avoid wasting time and effort which would otherwise be spent in manually programming a more complex navigation system and fumbling with a more complex user interface. The time-saving features of the present invention may be particularly beneficial when time is of the essence, for example, when business travelers and other users are running late to a meeting or are running late to the airport, and need quick, user-friendly navigational guidance.

It should be understood that the inventive concepts disclosed herein are capable of many modifications. To the extent such modifications fall within the scope of the appended claims and their equivalents, they are intended to be covered by this patent.

1. A method of pre-programming a vehicle navigation system, the method comprising the acts of:
receiving location information for a limited number of desired destinations as specified by a user; and
mapping the desired destinations to a user input interface,
wherein the act of mapping the desired destinations is performed prior to the user entering the vehicle.

2. The method of claim 1, wherein the location information is provided by the user via a client device remotely located from the vehicle.

3. The method of claim 1, wherein the location information is provided by the user via a web interface prior to the user entering the vehicle.

4. The method of claim 1, wherein the location information is provided by the user via a voice call prior to the user entering the vehicle.

5. The method of claim 1, wherein the location information is received from a server remote from the vehicle.

6. The method of claim 1, wherein the location information comprises a street address designated by the user prior to the user entering the vehicle.

7. The method of claim 1, wherein one of the desired destinations comprises a location of a car rental agency.

8. The method of claim 1, wherein one of the desired destinations comprises a location of an airport.

9. The method of claim 1, wherein one of the desired destinations comprises a location of a hotel designated by the user prior to the user entering the vehicle.

10. The method of claim 1, wherein one of the desired destinations comprises a location of a place of business designated by the user prior to the user entering the vehicle.

11. The method of claim 1, wherein user input interface comprises a display configured to display information designated by the user prior to the user entering the vehicle.

12. A method of providing limited-destination navigational guidance to a user when driving a vehicle, the method comprising the acts of:
receiving location information for a limited number of desired destinations;
mapping the desired destinations to a user input interface;
receiving GPS data relating to a present position of the vehicle; and
providing navigational guidance to the user upon selection of the user input interface;
wherein the act of mapping the desired destinations is performed prior to the user entering the vehicle.

13. The method of claim 12, wherein the location information comprises a street address designated by the user prior to the user entering the vehicle.

14. The method of claim 12, wherein one of the desired destinations comprises a location of a car rental agency.

15. The method of claim 12, wherein the user interface comprises a display configured to display text designated by the user prior to the user entering the vehicle.

16. A system for providing limited-destination navigational guidance to a user when driving a vehicle, the system comprising:
a processor;
a memory coupled to the processor,
wherein the memory is pre-configured to store location information for a limited number of desired destinations, prior to the user entering the vehicle;
a user interface coupled to the processor,
wherein the user interface comprises one or more actuators,
wherein each of the one or more actuators is linked to location information for one of the desired destinations, and
wherein the user interface is configured to provide navigational guidance information; and
a network interface coupled to the processor.

17. The system of claim 16, wherein the navigational guidance information comprises audible information.

18. The system of claim 16, wherein the navigational guidance information comprises visual information.

19. The system of claim 16, wherein the network interface provides a connection to a vehicle data bus.

20. The system of claim 16, wherein the network interface comprises a wireless receiver.
